(19) United States
(12) Patent Application Publication
(10) Pub. No.: US 2019/0228176 A1
(43) Pub. Date: Jul. 25, 2019

(54) SYSTEM AND METHOD FOR PROVIDING A PREDICTION-BASED DATA STRUCTURE HAVING DIFFERENT-SCHEME-DERIVED PORTIONS

(71) Applicant: Griffin Group Global, LLC, Great Falls, VA (US)

(72) Inventors: Jonathan B. FISHBECK, Great Falls, VA (US); William F. HEAPES, Barboursville, VA (US); Matthew JENKS, Charlottesville, VA (US)

(21) Appl. No.: 16/118,177

(22) Filed: Aug. 30, 2018

Related U.S. Application Data
(63) Continuation-in-part of application No. 15/876,034, filed on Jan. 19, 2018, now Pat. No. 10,078,759.

(51) Int. Cl. G06F 21/62; G06F 17/30; H04L 9/08

(52) U.S. Cl. CPC G06F 21/6227; H04L 9/0816; G06F 21/6209; G06F 17/30958

(57) ABSTRACT

In certain embodiments, a prediction model is caused to predict first information related to second information. A data structure may be created that comprises (i) a header (ii) a body in which the first and second information are to be represented by first and second data structure portions: (a) encrypting the first information with a cryptographic key to generate the first data structure portion, the first data structure portion being generated using the cryptographic key and without using another cryptographic key; (b) encrypting the second information with the other cryptographic key to generate the second data structure portion, the second data structure portion being generated using the other cryptographic key and without using the cryptographic key; and (c) creating the data structure comprising the first and second data structure portions. The data structure may be provided to a user device.

### RELATED APPLICATIONS

This application is a continuation-in-part of U.S. patent application Ser. No. 15/876,034, filed Jan. 19, 2018, which is related to U.S. patent application Ser. No. 15/876,016, filed Jan. 19, 2018, each of which is hereby incorporated by reference herein in its entirety.

### FIELD OF THE INVENTION

The invention relates to a data structure having different-scheme-derived portions, including, for example, creation of such data structure, use of such data structure to securely share information, etc.

### BACKGROUND OF THE INVENTION

Computer systems may facilitate the adoption of software applications that power specific aspects of various businesses. These software applications perform specific tasks allowing one or more individuals and groups to collaborate, perform defined functions, track or retain specific data; however, traditional computer systems may not facilitate sharing data from one application to the next in a highly secure and organized manner. For example, traditional business systems generally rely merely on security of the transmission pipeline and host-based boundary protections (e.g., firewalls) along with traditional role-based or user-based permissions to facilitate data sharing. Such business systems typically require separate downloadable files (or other data structures) for each piece of information that has a different set of permissions (e.g., designating which user can access that piece of information) from other information, thereby increasing the number of downloadable files/data structures to be stored on computers hosting such information. These and other drawbacks exist.

### SUMMARY OF THE INVENTION

Aspects of the invention relate to methods, apparatuses, and/or systems for facilitating secure data structures, distribution and security of information, and/or productivity applications and information.

In some embodiments, a prediction model is caused to predict first information related to second information. A data structure may be created that comprises (i) a header (ii) a body in which the first and second information are to be represented by first and second data structure portions: (a) encrypting the first information with a cryptographic key to generate the first data structure portion, the first data structure portion being generated using the cryptographic key and without using another cryptographic key; (b) encrypting the second information with the other cryptographic key to generate the second data structure portion, the second data structure portion being generated using the other cryptographic key and without using the cryptographic key; and (c) creating the data structure comprising the first and second data structure portions. The data structure may be provided to a user device.

In some embodiments, a data structure (including first and second data structure portions in a body of the data structure) may be obtained, where the first data structure portion is generated based on a first cryptographic scheme, and the second data structure portion is generated based on a second cryptographic scheme. The data structure may be processed to determine the first cryptographic scheme for extracting data from the first data structure portion and the second cryptographic scheme for extracting data from the second data structure portion. In some embodiments, an application may use the first cryptographic scheme to decrypt the first data structure portion to extract the first information from the first data structure portion, and the same application may use the second cryptographic scheme to decrypt the second data structure portion to extract the second information from the second data structure portion. The application may perform the decryption of the first data structure portion and the second data structure portion in parallel or in series.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for facilitating secure data structures, distribution and security of information, and/or productivity applications and information, in accordance with one or more embodiments.

FIGS. 2A-2E show representations of a data structure, a header of a data structure, and a body of a data structure, in accordance with one or more embodiments.

FIG. 2F shows a user interface used to access one or more files and representations of a file and a body of the file, in accordance with one or more embodiments.

FIGS. 2G and 2H show the opening of a respective data structure by two users and the respective content portions represented by the data structure being presented to the two users, in accordance with one or more embodiments.

FIGS. 3A and 3B show use cases related to transmission of a data structure from one computer to another computer, in accordance with one or more embodiments.

FIG. 4 shows a flowchart of a method of providing a data structure with different cryptographic schemes for different portions of the data structure, in accordance with one or more embodiments.

FIG. 5 shows a flowchart of a method of processing a data structure with different cryptographic schemes for different portions of the data structure, in accordance with one or more embodiments.

### DETAILED DESCRIPTION OF THE INVENTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other instances, well-known structures and devices are shown in block diagram form in order to avoid unnecessarily obscuring the embodiments of the invention.

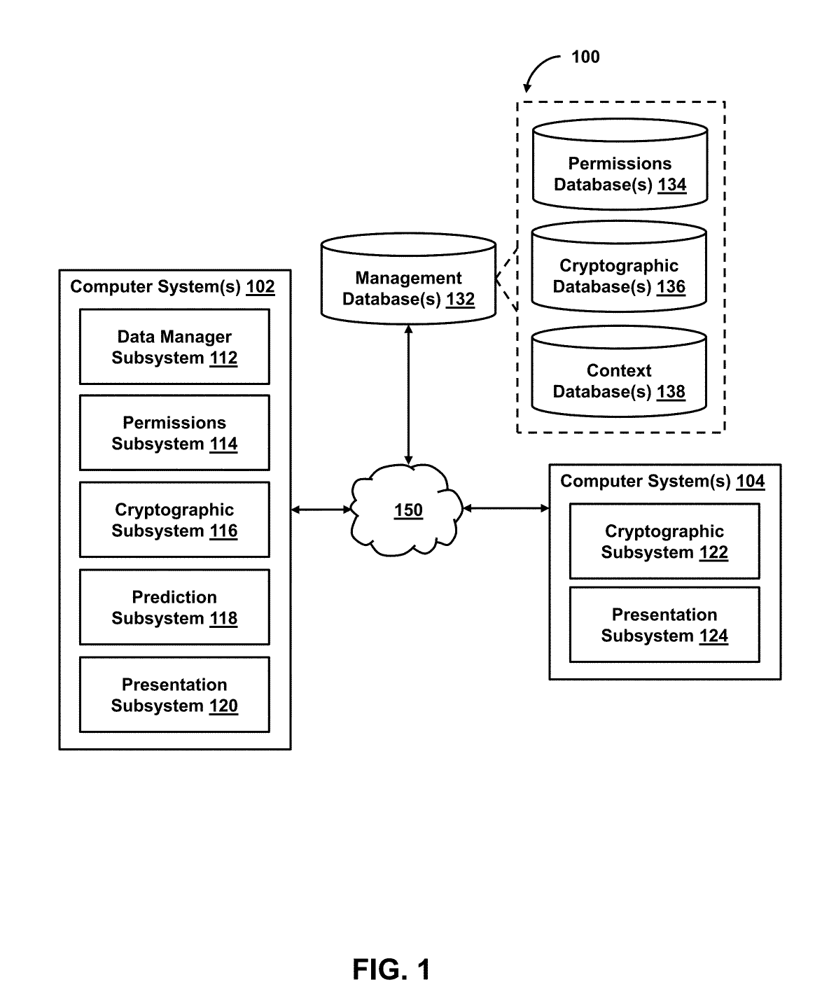

FIG. 1 shows a system 100 for facilitating secure data structures, distribution and security of information, and/or productivity applications and information, in accordance with one or more embodiments. As shown in FIG. 1, system 100 may include computer system(s) 102, computer system(s) 104, or other components. Computer system 102 may include data manager subsystem 112, permissions subsystem 114, cryptographic subsystem 116, prediction subsystem 118, presentation subsystem 120, or other components. Computer system 104 may include cryptographic subsystem 122, presentation subsystem 124, or other components.

In some embodiments, computer system 102 may be a server-side computer system, and computer system 104 may be a client-side computer system (e.g., one or more client devices). In some embodiments, each of computer system 102 and computer system 104 may be a server-side computer system. In some embodiments, each of computer system 102 and computer system 104 may be a client-side computer system (e.g., a client device). Each client device may include any type of mobile terminal, fixed terminal, or other device. By way of example, a client device may include a desktop computer, a notebook computer, a tablet computer, a smartphone, a wearable device, or other client device. Users may utilize one or more client devices to interact with one another, one or more servers, or other components of system 100. It should be noted that, while one or more operations are described herein as being performed by particular components of computer system 102, those operations may, in some embodiments, be performed by other components of computer system 102 or other components of system 100. As an example, while one or more operations are described herein as being performed by components of computer system 102, those operations may, in some embodiments, be performed by components of computer system 104. As another example, while one or more operations are described herein as being performed by components of computer system 104, those operations may, in some embodiments, be performed by components of computer system 102.

In some embodiments, system 100 may facilitate secure data structures, distribution and security of information, and/or productivity applications and information. Such data structures may be files, linked lists, arrays, records, or other data structures. In some embodiments, system 100 may generate a data structure that includes a portion representing first information (e.g., text, audio, image, video, program, or other information) to be accessed by a first entity or set of entities, a portion representing second information to be accessed by a second entity or set of entities, or other portions. As an example, entities other than the first entity or set of entities would be prevented from accessing the first information via the data structure even if those other entities gains access to the data structure, and entities other than the second entity or set of entities would be prevented from accessing the second information via the data structure even if those other entities gains access to the data structure. As a further example, even though the first entity may access the first information via the data structure, the first entity may not be able to access the second information via the data structure (or vice versa). In this way, for example, the data structure may be made accessible to a plurality of entities (e.g., including those for which some or all portions of the data structure are not intended) via a website or other platform without causing the information represented by the data structure to be accessed by entities for which the information is not intended even if some such information is intended for and accessible by the entities via the data structure. Additionally, or alternatively, unnecessary creation of multiple variations of a set of information may be avoided, thereby reducing computational resources related to sharing of such information. For example, system 100 need not necessarily create different variations of the set of information for different sets of entities as different files (or other data structures) to prevent entities of one of the sets of entities from gaining access to information intended only for another one of the sets of entities.

In some embodiments, each of the data structures portions may not itself be a data structure independent of the data structure that includes such portion. As an example, each of the data structure portions may not include header or other information configured to indicate what application(s) or type of application(s) is/are to be used to access (e.g., read, write, execute, etc.) the content of the respective data structure portion or how to process/interpret the content (e.g., how to parse the content or other specifications). As another example, if the data structure is a file, neither the portion representing the first information nor the portion representing the second information may be configured to be its own separate file. In one use case, for instance, the file may include a header and a body, the two portions may be two portions of the file's body, and neither of the two body portions may include its own header (e.g., that a computer program would use to determine how to parse the body portion).

In some embodiments, system 100 may determine one or more cryptographic schemes to be used to generate different portions of a data structure based on permissions associated with the respective information represented by the different data structure portions. Each of the cryptographic schemes may include use of a different cryptographic key (as compared to another cryptographic scheme used to generate another portion of the data structure), use of a different one of a symmetric cryptographic scheme or an asymmetric cryptographic scheme (as compared to another cryptographic scheme used to generate another portion of the data structure), etc.

As an example, as part of providing a data structure that includes representations of first and second information (e.g., first and second content portions), system 100 may obtain a first set of permissions associated with the first information (e.g., to determine what entity or set of entities may access the first information) and a second set of permissions associated with the second information (e.g., to determine what entities or set of entities may access the second information). The first set of permissions may grant write access, read access, execute access, delete access, or other type of access for one or more first entities (or one or more first groups of entities). The second set of permissions may grant write access, read access, execute access, delete access, or other type of access for one or more second entities (or one or more second groups of entities). System 100 may determine a first cryptographic scheme for the first information based on the first set of permissions being associated with the first information and a second cryptographic scheme for the second information based on the second set of permission being associated with the second information. System 100 may then generate a first data structure portion (that represents the first information in the data structure) based on the first cryptographic scheme and a second data structure portion (that represents the second information in the data structure) based on the second cryptographic scheme. System 100 may automatically perform one or more of the obtainment of the permissions, the determination of the cryptographic schemes, the generation of the data structure portions for the data structure, or other operations described herein. As an example, system 100 may perform the obtainment of the permissions without any further user input (i) provided subsequent to system 100 obtaining a request to create the data structure and (ii) specifying the permissions (e.g., any of the permissions, all of the permissions, etc.). As another example, system 100 may perform the determination of the cryptographic schemes and the generation of the data structure portions without any further user input (i) provided subsequent to system 100 obtaining the request to create the data structure and (ii) specifying the cryptographic schemes (e.g., any of the cryptographic schemes, all of the cryptographic schemes, etc.).

In some embodiments, system 100 may cause one or more applications to use different cryptographic schemes to encrypt multiple portions of content (e.g., first information, second information, etc.) to generate the data structure portions of a data structure that respectively correspond to the content portions. For example, upon generation by an application (e.g., a computer program, a mobile application, or other application), a first data structure portion of the data structure may include an encrypted version of a first content portion (e.g., encrypted by the application with a first cryptographic scheme), a second data structure portion of the data structure may include an encrypted version of a second content portion (e.g., encrypted by the application with a second cryptographic scheme different from the first cryptographic scheme), a third data structure portion of the data structure may include an encrypted version of a third content portion (e.g., encrypted by the application with a third cryptographic scheme different from the first and second cryptographic schemes), and so on. As a further example, the first cryptographic scheme may be selected (e.g., by the application or other application for encrypting the first content portion) based on a first set of permission being associated with the first content portion, the second cryptographic scheme may be selected (e.g., by the application or other application for encrypting the second content portion) based on a second set of permission being associated with the second content portion, the third cryptographic scheme may be selected e.g., (by the application or other application for encrypting the third content portion) based on a third set of permission being associated with the first content portion, and so on. In some embodiments, the application may automatically perform one or more of obtainment of the permissions, the determination/selection of the cryptographic schemes, the generation of the data structure portions for the data structure, or other operations described herein. As an example, the application may perform the obtainment of the permissions without any further user input (i) provided subsequent to the application obtaining a request to create the data structure and (ii) specifying the permissions (e.g., any of the permissions, all of the permissions, etc.). As another example, the application may perform the determination/selection of the cryptographic schemes and the generation of the data structure portions without any further user input (i) provided subsequent to the application obtaining the request to create the data structure and (ii) specifying the cryptographic schemes (e.g., any of the cryptographic schemes, all of the cryptographic schemes, etc.). As a further example, the application may perform some or all of the foregoing automatic operations within a short period of time (e.g., the determination/section of the cryptographic schemes and the generation of the data structure portions or other operations within two seconds, within one second, within ten milliseconds, within one millisecond, etc.).

In some embodiments, system 100 may process a data structure having one or more cryptographic-scheme-derived portions to facilitate access to information corresponding to the data structure portions. As an example, responsive to obtaining the data structure, system 100 may process the data structure to determine a first cryptographic scheme for extracting data from a first data structure portion of the data structure and a second cryptographic scheme for extracting data from a second data structure of the data structure. System 100 may obtain first information from the first data structure portion based on the first cryptographic scheme and second information from the second data structure portion based on the second cryptographic scheme. In some embodiments, responsive to a user's request to access at least one of the data structure portions (or the corresponding content portions), system 100 determines which content portions are extractable by the user. As an example, with respect to each of the data structure portions, system 100 determines whether the user is associated with a cryptographic scheme that can be used to decrypt the data structure portion to extract the corresponding content portion. Based on such determination, system 100 may decrypt only the data structure portions that can be decrypted with the user's associated cryptographic schemes (e.g., and ignore the other data structure portions that are only decryptable with cryptographic schemes with which the user is not associated) thereby avoiding unnecessary use of computational resources for attempted decryptions and/or presentation of incorrect data (e.g., resulting from attempt decryptions with incorrect keys). System 100 may automatically perform one or more of the determination of the cryptographic schemes (e.g., including which cryptographic schemes are associated with the user or other related determinations), the obtainment of the information from the data structure portions, or other operations described herein. As an example, system 100 may perform the determination of the cryptographic schemes and the obtainment of the information from the data structure portions without any further user input (i) provided subsequent to system 100 obtaining a request to access at least one of the data structure portions (or the corresponding content portions) and (ii) specifying the cryptographic schemes (e.g., any of the cryptographic schemes, all of the cryptographic schemes, etc.).

In some embodiments, system 100 may cause one or more applications to use different cryptographic schemes to decrypt multiple data structure portions of a data structure to extract portions of content (e.g., first information, second information, etc.) that respectively correspond to the data structure portions. For example, a first data structure portion of the data structure may include an encrypted version of a first content portion, a second data structure portion of the data structure may include an encrypted version of a second content portion, a third data structure portion of the data structure may include an encrypted version of a third content portion, and so on. As a further example, based on a processing of header or other information of the data structure portion (e.g., by an application, such as a mobile application or other application), first, second, and third cryptographic schemes may be selected (e.g., by the application) for decrypting the first, second, and third data structure portions, respectively. In some embodiments, one application (e.g., the same application that selected the cryptographic schemes or other application) may use the selected cryptographic schemes to decrypt the first, second, and third data structure portions to extract the first, second, and third content portions, respectively. In some embodiments, the application may automatically perform one or more of the determination/selection of the cryptographic schemes, the decryption/extraction based on the cryptographic schemes, or other operations described herein. As an example, the application may perform the determination/selection of the cryptographic schemes and the extraction of the content portions without any further user input (i) provided subsequent to the application obtaining a request to access at least one of the data structure portions (or the corresponding content portions) and (ii) specifying the cryptographic schemes (e.g., any of the cryptographic schemes, all of the cryptographic schemes, etc.).

In one use case, the application may read the header or other information of the data structure to determine whether and/or which of the data structure portions corresponds to a content portion intended for the current user of the application. For example, if a given content portion is intended for a user group (e.g., users with a certain role, users with a certain access level, etc.) with which the user is associated, a header or other part of the data structure may indicate that the content portion is intended for the user group (e.g., by specifying the user group's identifier, access level, or other attributes of the user group in association with the data structure portion corresponding to the content portion). The application may determine that the content portion is intended for the user based on its determination that the content portion is intended for the user group and that the user is part of the user group. Based on such determination, the application may obtain a cryptographic key associated with the user group and use the cryptographic key to decrypt the data structure portion (corresponding to the content portion) to extract the content portion from the corresponding data structure portion. As another example, if a given content portion is intended only for the current user, a header or other part of the data structure may specify the user's identifier or other attribute of the user in association with the data structure portion corresponding to the content portion. Based on the specified association, the application may obtain a cryptographic key associated with the user and use the cryptographic key to decrypt the data structure portion (corresponding to the content portion) to extract the content portion from the corresponding data structure portion. In some use cases, one or more cryptographic keys may be stored on the user's client device, and the application may obtain the cryptographic keys from a secure memory of the client device. In some use cases, one or more cryptographic keys may be stored on a server-side computer system (e.g., on behalf of the user), and the application may obtain the cryptographic keys from the server-side computer system (or a database associated therewith).

In some embodiments, system 100 may facilitate prediction-model-based (i) creation of secure data structures, (ii) distribution and security of information, and/or (iii) generation and updating of action items, events (e.g., electronic appointment, meeting invitation, etc., with times, locations, attachments, attendees, etc.), conversations, documents, or other items. The prediction models may include neural networks, other machine learning models, or other prediction models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function that combines the values of all its inputs together. In some embodiments, each connection (or the neural unit itself) may have a threshold function such that the signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

In some embodiments, system 100 may obtain content items, permissions associated with such content items (or portions thereof), or other training information and cause one or more prediction models to be trained based on the training information to create secure data structures, manage accessibility of information (e.g., by distributing information in such secure data structures, by implementing permission-based access to any and all parts of a file or other data structure, etc.), and/or generate and update content items. As an example, the number of content items (along with their respective permissions) used to train the prediction models may be 500 or more content items (along with their respective permission), 1000 or more content items (along with their respective permissions), 10000 or more content items (along with their respective permissions), 100000 or more content items, 1000000 or more content items (along with their respective permissions), or other number of content items (along with their respective permissions). The content items may include action items, events, conversations, documents, or other items (including text, images, audios, videos, programs, etc., in such items).

Subsystems 112-120

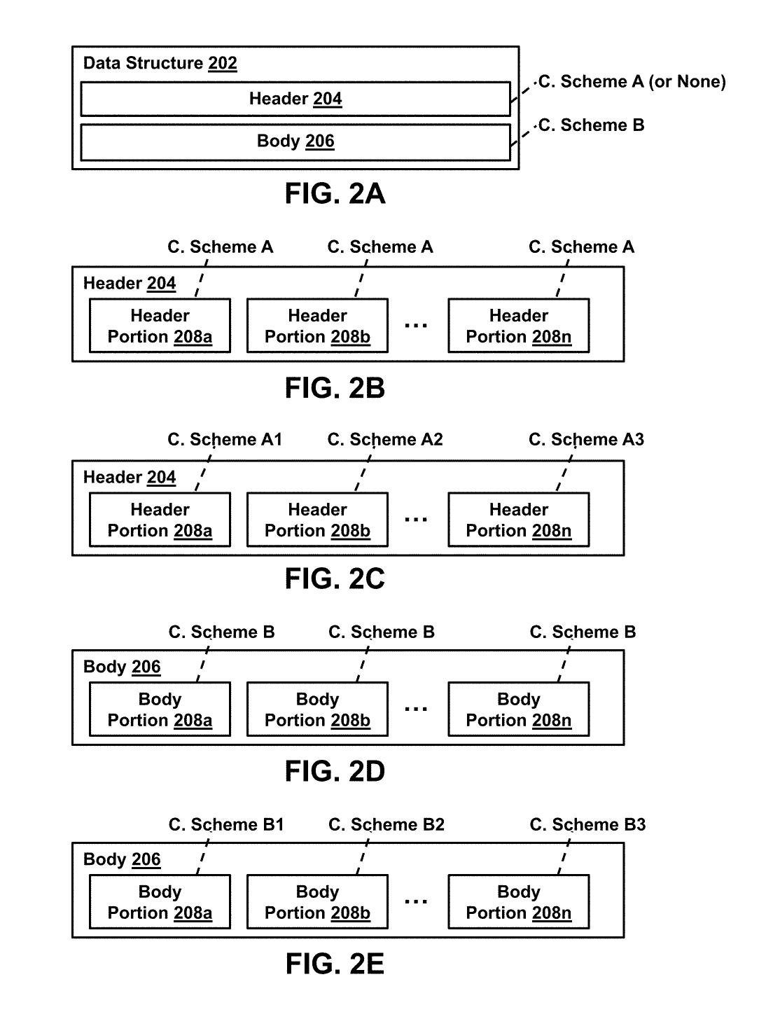

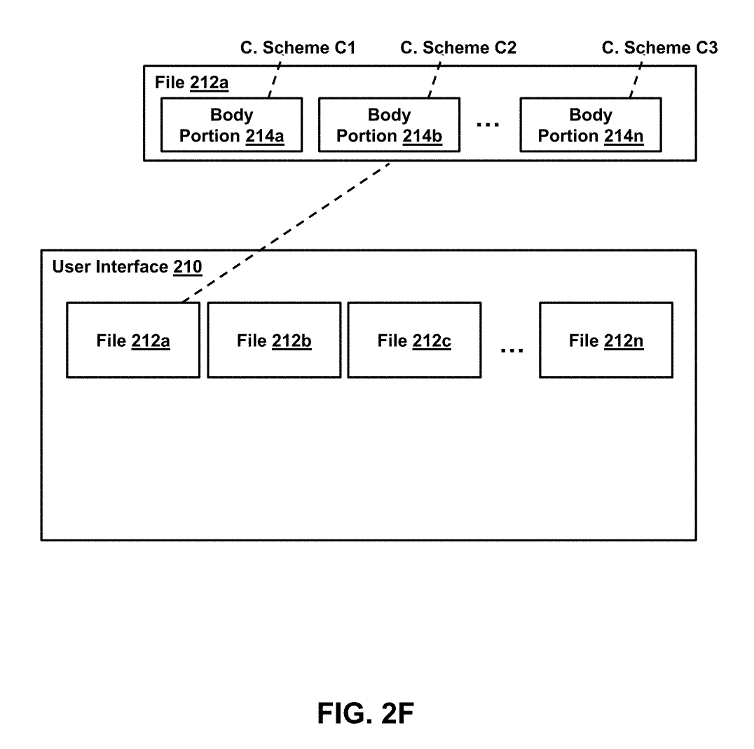

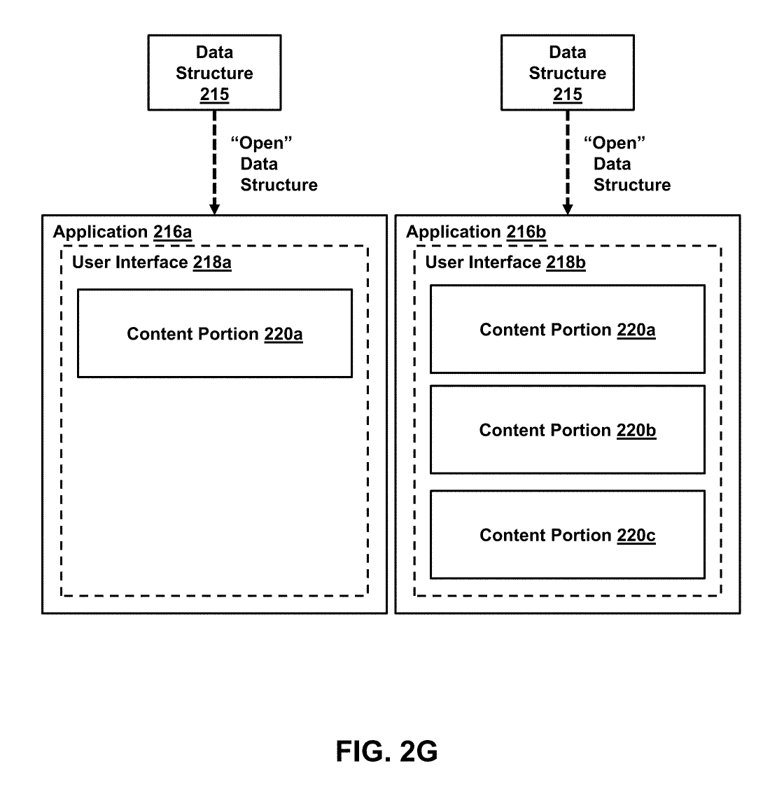

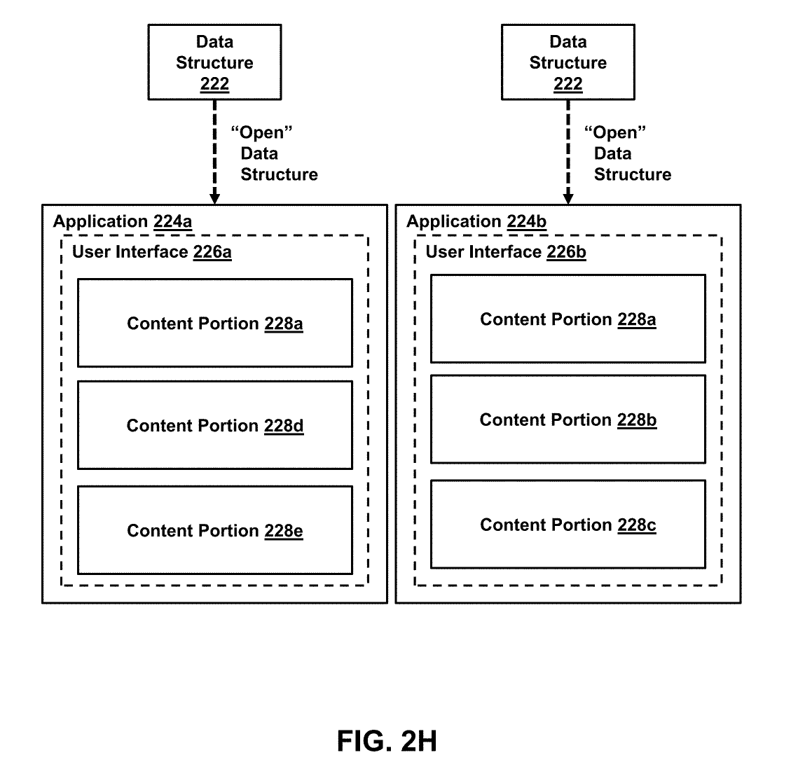

In some embodiments, data manager subsystem 112 is configured to obtain information to be represented in a data structure accessible to a plurality of entities, and cryptographic subsystem 116 is configured to determine one or more cryptographic schemes for the information to generate one or more data structure portions for the data structure. As an example, data manager subsystem 112 may obtain first information, second information, or other information (e.g., first portion of content, second portion of content, etc.) to be respectively represented in a first data structure portion, a second data structure portion, or other data structure portion of the data structure. In some embodiments, the data structure may include a file, linked list, array, record, or other data structure, and the file, linked list, array, record, or other data structure may include the first and second data structure portions (or other data structure portions). In some embodiments, data manager subsystem 112 is configured to provide the data structure (including the first and second data structure portions) such that the data structure is accessible to one or more entities. In one use case, as shown in FIG. 2A, data structure 202 may include header 204 and body 206, where a non-encrypted version of data structure 202 includes (1) header 204 that is encrypted via a cryptographic scheme A or that is not encrypted and (2) body 206 that is encrypted via cryptographic scheme B. In another use case, as shown in FIG. 2B, header 204 may include a plurality of header portions (e.g., header portion 208a, header portion 208b, etc.), where each of the header portions may be encrypted with the same cryptographic scheme (e.g., cryptographic scheme A). However, as shown in FIG. 2C, each of the header portions may be encrypted with a different cryptographic scheme (e.g., cryptographic scheme A1 for header portion 208a, cryptographic scheme A2 for header portion 208b, etc.). In another use case, as shown in FIG. 2D, body 206 may include a plurality of body portions (e.g., body portion 208a, body portion 208b, etc.). In some embodiments, each of the body portions may be encrypted with the same cryptographic scheme (e.g., cryptographic scheme B). However, in another use case, as shown in FIG. 2E, each of the body portions may be encrypted with a different cryptographic scheme (e.g., cryptographic scheme B1 for body portion 208a, cryptographic scheme B2 for body portion 208b, etc.).

Returning to FIG. 1, in some embodiments, permissions subsystem 114 is configured to determine one or more permissions associated with information (that is to be represented in a data structure), and cryptographic subsystem 116 is configured to determine one or more cryptographic schemes for the information based on the determined permissions to generate one or more data structure portions for the data structure. As an example, where first and second information (e.g., first and second portions of content) are to be cryptographically represented in the form of first and second data structure portions of the data structure, permissions subsystem 114 may determine a first set of permissions associated with the first information and a second set of permissions associated with the second information. Cryptographic subsystem 116 may determine a first cryptographic scheme for the first information (e.g., based on the first set of permissions being associated with the first information) and a second cryptographic scheme for the second information (e.g., based on the second set of permission being associated with the second information). Cryptographic subsystem 116 may generate the data structure by generating the first data structure portion based on the first cryptographic scheme and generating the second data structure portion based on the second cryptographic scheme. As an example, the first and second cryptographic schemes (on which generation of the first and second data structure portions are respectively based) may be different from one another. In one use case, the first cryptographic scheme may include use of a first cryptographic key associated with a first entity, and the second cryptographic scheme may include use of a second cryptographic key associated with a second entity (e.g., different from the first cryptographic key). In another use case, the first cryptographic scheme may include use of a symmetric key associated with the first entity, and the second cryptographic scheme may include use of an asymmetric key associated with the second entity.

In some embodiments, permission subsystem 114 may obtain the first set and the second set of permissions from permissions database 134 (or other database). As an example, the first set of permissions may grant write access, read access, execute access, delete access, or other type of access for one or more first entities (or one or more first groups of entities). The second set of permissions may grant write access, read access, execute access, delete access, or other type of access for one or more second entities (or one or more second groups of entities). In one use case, with respect to FIG. 2G, content portion 220a may be associated with the first set of permissions (such as user role A, access level A, etc.), and content portions 220b and 220c may be associated with the second set of permissions (such as user role B, access level B, etc.). Based on the first set of permissions being associated with content portion 220a, cryptographic subsystem 116 may determine the first cryptographic key (e.g., a shared secret or other cryptographic key) as a key to be used to encrypt content portion 220a to produce data structure portion A (or an encrypted version of content portion 220a). Based on the second set of permissions being associated with content portions 220b and 220c, cryptographic subsystem 116 may determine the second cryptographic key (e.g., a public key of a public/private key pair or other cryptographic key) as a key to be used to encrypt content portions 220b and 220c to produce data structure portions B and C (or encrypted versions of content portions 220b and 220c).

In some embodiments, cryptographic subsystem 116 may generate the data structure to indicate in a header or other portion of the data structure (e.g., a file or other data structure) what portions of the data structure to show depending on what user application opened the data structure (e.g., a browser type or application ID), what user device opened the file (e.g., a device type or device ID), what user opened the data structure (e.g., user type or user ID), or other criteria. In some embodiments, cryptographic subsystem 116 may generate the data structure to indicate (in a header or other portion of the data structure) one or more cryptographic keys (e.g., symmetric key, asymmetric key, etc.) that are to be used to decrypt one or more portions of the data structure. As an example, for the first data structure portion of the data structure, such indication may be provided by specifying one or more identifiers of the first entities/groups of entities (with which the first set of permissions is associated) to indicate that the first information (corresponding to the first data structure portion) is intended to be accessed the first entities/groups of entities. For the second data structure portion of the data structure, such indication may be provided by specifying one or more identifiers of the second entities/groups of entities (with which the second set of permissions is associated) to indicate that the second information (corresponding to the second data structure portion) is intended to be accessed the second entities/groups of entities. In one use case, for instance, upon obtaining the data structure, an application (e.g., a mobile application or other application) may process the header (or other such portion) of the data structure to determine whether the current user of the application corresponds to any of the specified identifiers. If so, the application (e.g., the mobile application) may obtain one or more of the user's cryptographic keys to be used to extract information (intended for the user's access) from the respective data structure portions.

In some use cases, with respect to FIG. 2G, content portion 220a may include a list of allegories and corresponding desired meals without the names of the individuals, and content portions 220b or 220c may include the names or other personal information of the individuals who have such allergies and desire such meals. In its header or other part of data structure 215, data structure 215 may specify a user role A or an access level A for data structure portion A, where a chef, other meal preparers, and certain event managers are assigned to the user role A or satisfy access level A (e.g., they have access level A or an access level exceeding access level A). In its header or other part of data structure 215, data structure 215 may further specify a user role B or an access level B for data structure portions B and C, where the certain event managers are assigned to the user role B or satisfy access level B (where the chef or other meal preparers are not assigned to user role B or fail to satisfy access level B). Based on a processing of data structure 215, each application 216 may determine what user roles or access levels are specified for each of the data structure portions A, B, and C. If the application 216 determines that its user has a user role or access level satisfying a user role or access level specified for a data structure portion, the application 216 may attempt to retrieve the cryptographic key necessary to decrypt that data structure portion to extract the corresponding content from the data structure portion.

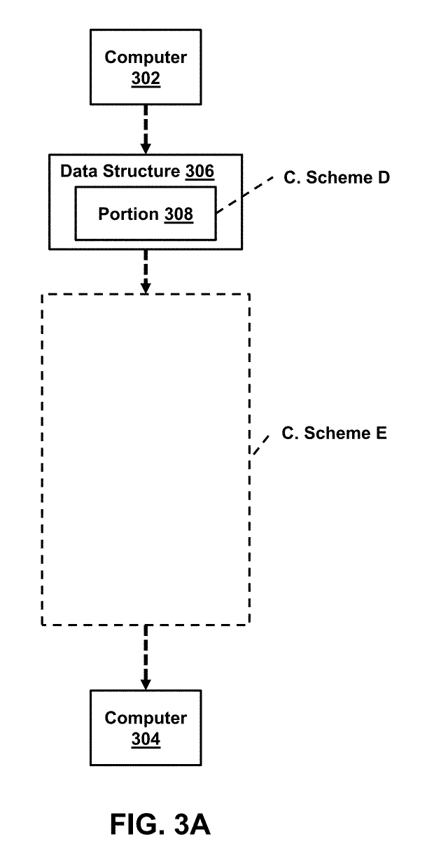

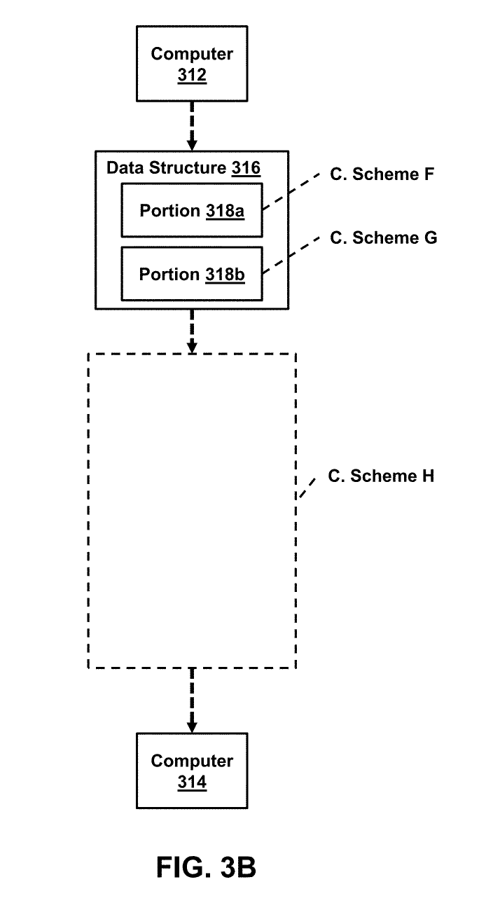

In some embodiments, with respect to FIG. 3A, computer 302 may generate data structure 306 (e.g., medical list of allergies) for transmission to computer 304. In this example, data structure 306 may include a portion 308 generated based on a cryptographic scheme D (e.g., by encrypting the corresponding information with a first encryption key to produce portion 308).

Additionally, data structure 306 may be encrypted via an overall cryptographic scheme E (e.g., encrypted with another encryption key to secure the transmission pipeline). With respect to FIG. 3A, a general user attempting to access data structure 306 would not be able to view any part of data structure 306 (and would only have access to the encrypted version of data structure 306). However, a user who has access to the corresponding keys (e.g., corresponding to the keys used for encryption) would have access to the contents of portion 308 (and/or the contents of other portions of data structure 306).

Returning to FIG. 1, in some embodiments, cryptographic subsystem 116 is configured to generate a first data structure portion of a data structure based on a first cryptographic scheme, a second data structure portion of the data structure based on a second cryptographic scheme, or one or more other data structure portion of the data structure based on one or more other cryptographic schemes. As generated, the first data structure portion may represent first information (e.g., a first portion of content), and the second data structure portion may represent second information (e.g., a second portion of content). In some embodiments, cryptographic subsystem 116 may use (i) the first cryptographic key (e.g., a symmetric key or other type of cryptographic key) to encrypt the first information to produce the first data structure portion and (ii) the second cryptographic key (e.g., an asymmetric key or other type of cryptographic key) to encrypt the second information to produce the second data structure portion. In some embodiments, the first data structure is generated without use of the second cryptographic key. In some embodiments, the second data structure portion is generated without use of the first cryptographic key. In one use case, for example, the data structure may be a file that includes contact information. In this example, a first portion (e.g., the business information) of the contact information may be encrypted with a symmetric key. Users that have been provided with the asymmetric key (e.g., employee of the same company) may decrypt the business contact information. Furthermore, personal information (which may not be desired to be viewed by everyone) may be encrypted using a personal key tied to an asymmetric encryption scheme.

In some embodiments, where first and second information (e.g., first and second portions of content) are to be cryptographically represented in the form of first and second data structure portions of the data structure, cryptographic subsystem 116 is configured to generate the first data structure portion and the second data structure portion by (i) using a symmetric cryptographic scheme (e.g., a symmetric cryptographic algorithm, a symmetric key compatible with such algorithm, etc.) to encrypt the first information to produce the first data structure portion and (ii) using an asymmetric cryptographic scheme (e.g., an asymmetric cryptographic algorithm, an asymmetric key compatible with such algorithm, etc.) to encrypt the second information to produce the second data structure portion. In some embodiments, the first data structure portion is generated without use of the asymmetric cryptographic scheme (e.g., without use of the asymmetric key). In some embodiments, the second data structure portion is generated without use of the symmetric cryptographic scheme (e.g., without use of the symmetric key).

As an example, with respect to FIG. 3B, data structure 316 may include portion 318a generated based on a cryptographic scheme F (e.g., a symmetric encryption key or other encryption key) and portion 318b generated based on a cryptographic scheme G (e.g., an asymmetric encryption key or other encryption key different from the key via which portion 318a is generated). Additionally, data structure 316 may be encrypted via an overall cryptographic scheme H (e.g., encrypted with another encryption key to secure the transmission pipeline). In one use case, where data structure 316 represents a list of allergies of individuals for an event, portion 318a may include an encrypted version of the allergies and corresponding desired meals without the names of the individuals who have such allergies and desire such meals, and portion 318b may include an encrypted version of the names of the individuals who have such allergies and desire such meals. As such, in another use case, data structure 316 may indicate (e.g., in its header or other part thereof) that the contents of portion 318a is intended for a chef or others preparing the meals for the event and certain event managers for the event and that the contents of portion 318b is intended for the certain event managers. As an example, in its header or other part of data structure 316, data structure 316 may specify a user role A or an access level A for portion 318a, where the chef/other meal preparers and the certain event managers are assigned to the user role A or satisfy access level A (e.g., they have access level A or an access level exceeding access level A). In its header or other part of data structure 316, data structure 316 may further specify a user role B or an access level B for portion 318b, where the certain event managers are assigned to the user role B or satisfy access level B (and where the chef or other meal preparers are not assigned to user role B or fail to satisfy access level B). This would allow the chef/other meal preparers to access the list of allergies and desired meals but not to the specific list of individuals to which the allergies and desired meals apply.

In some embodiments, data manager subsystem 112 or cryptographic subsystem 116 may associate one or more expiration times with one or more content items, data structures, portions within such content items or data structures, cryptographic keys, or other items. In some embodiments, an expiration time may be assigned to a data structure or a portion thereof based on an expiration time associated with a content item. An expiration time may specify an absolute expiration time (e.g., a given date/time at which an item expires) or a relative expiration time (e.g., one day, one week, or other amount of time from a creation time, from a replacement time at which a prior instance had been replaced, etc.). As an example, one or both of the data structure or the data structure portion (e.g., that cryptographically represents the content item) may have the same expiration time as the expiration time associated with the content item. In some embodiments, where a data structure includes multiple data structure portions (that each represents a respective content item), each of such data structure portions may be associated with a respective expiration time (e.g., that is the same as the expiration time of the represented content item). In further embodiments, where the data structure is associated with an expiration time, the expiration time of the data structure may be the same or different from at least one of the expiration times of the data structure portions. As an example, the data structure's expiration time may be the same as a first data structure portion's expiration time, but may be different from a second data structure portion's expiration time. As another example, the data structure's expiration time may be the earliest of the expiration times of the data structure portions (of the data structure). As another example, the data structure's expiration time may be the latest of the expiration times of the data structure portions.

In some embodiments, an expiration time may be assigned to a data structure or a portion thereof based on an expiration time associated with a cryptographic key (e.g., used to encrypt a content item and generate the data structure portion, used to decrypt the data structure portion and obtain the content item, etc.). In some embodiments, the cryptographic key may be assigned its expiration time based on an expiration time associated with the content item. As an example, the data structure, the data structure portion (e.g., that cryptographically represents the content item), or the cryptographic key may have the same expiration time as the expiration time associated with the content item. In some embodiments, where a data structure includes multiple data structure portions (that each represents a respective content item), an cryptographic key associated with an expiration time may have been used to generate each of such data structure portions. In further embodiments, where the data structure is associated with an expiration time, the expiration time of the data structure may be the same or different from at least one of the expiration times of the cryptographic keys. As an example, the data structure's expiration time may be the same as the expiration time of a first cryptographic key used to generate a first data structure portion (or usable to obtain content from the first data structure portion), but may be different from the expiration time of a second cryptographic key used to generate a second data structure portion (or usable to obtain content from the first data structure portion). As another example, the data structure's expiration time may be the earliest of the expiration times of such cryptographic keys. As another example, the data structure's expiration time may be the latest of the expiration times of such cryptographic keys.

In some embodiments, with respect to a data structure available to one or more entities, data manager subsystem 112 may replace an instance of the data structure or instances of its data structure portions with another instance of the data structure or other instances of the data structure portions based on one or more expiration times (e.g., expiration times associated with the data structure, the data structure portions, the cryptographic keys used to generate the data structure portions, the content items represented by the data structure portions, instances of the foregoing items, etc.). As an example, upon such replacement, the replaced instances are no longer available to the entities, and the replacing instances become available to the entities in lieu of the replace instances. In some embodiments, one or more cryptographic keys different from the cryptographic keys used to encrypt the content items (represented by the data structure portions) may be used to encrypted the content items to regenerate new instances of the data structure portions. In this way, upon replacement, old cryptographic keys (e.g., expired keys) cannot be used to decrypt the new instances that are now available to the entities (e.g., in lieu of the old instances that were previously available to such entities). As an example, a user that had access to the old cryptographic keys may not be able to access the content items (represented by the data structure portions) if the user downloads the new instance of the data structure (that includes the new instances of the data structure portions). The new instance of the data structure may, for example, replace the old instance of the data structure on a web page, mobile application, or other interface via which the data structure is available to the user (e.g., such that the old instance is no longer available via the same web page or mobile application).

In some embodiments, data manager subsystem 112 may automatically replace first instance(s) of a data structure or its data structure portions with second instance(s) of the data structure or its data structure portions on a periodic basis, in accordance with a schedule, or responsive to one or more other automated triggers (e.g., the expiration times). In some embodiments, such instances may be automatically replaced without regard to whether (or not) the instances represent updated versions of the content items represented by the data structure portions (e.g., without regard to whether all or any of the content items represented by the data structure portions have been updated). In one use case, instances of the data structure portions of the data structure may be stored as separate portions on one or more data storages (e.g., one or more web caches of servers, other caches of the servers, or other data storage), and the instances of the data structure portions may referenced by one or more links (e.g., hyperlinks) or other pointers. Each of the instances of the data structure portions may be automatically replaced responsive to a determination that the data structure portion's expiration time has passed (e.g., the data structure portion has expired) such that, upon replacement, the link (or other pointer) that had referenced the replaced instance is now a link (or other pointer) referencing the replacing instance (e.g., the new instance of the data structure portion).

In another use case, an instance of the data structure may be reference by a link or other pointer. The instance of data structure may be automatically replaced responsive to (i) a determination that the data structure's expiration time has passed, (ii) at least one of the data structure portions' expiration times has passed (e.g., the earliest of the expiration times has passed), (iii) a predetermined threshold number of the data structure portions' expiration time have passed (e.g., half of the expiration times or other threshold number), or (iv) all of the data structure portions' expiration time have passed. Upon replacement of the data structure, the link (or other pointer) that had referenced the replaced instance is now a link (or other pointer) referencing the replacing instance (e.g., the new instance of the data structure).

Returning to FIG. 1, prediction subsystem 118 is configured to facilitate prediction-model-based (i) creation of secure data structures, (ii) distribution and security of information, and/or (iii) generation and updating of action items, events (e.g., electronic appointment, meeting invitation, etc., with times, locations, attachments, attendees, etc.), conversations, documents, or other items. Presentation subsystem 120 is configured to present, via one or more user interfaces, the action items, the events, the conversations, the documents, predictions of the foregoing items, or other information. In some embodiments, prediction subsystem 118 may enable one or more prediction models (e.g., described above) to be trained. Training data used to train the prediction models may include (i) a set of content items or information, (ii) reference outputs that are to be derived from a prediction model's processing of such content items or information (e.g., user-confirmed or user-provided outputs, outputs confirmed through one or more prediction models' processing of such content items, outputs confirmed multiple times by processing of such content items or information by respective sets of prediction models, or other reference outputs), (iii) reference indications of outputs that are not to be derived from a machine learning model's processing of such content items or information (e.g., user indications that such outputs are inaccurate or other reference indications), or (iv) other training data.

In some embodiments, upon obtaining a set of content items, model subsystem 114 may cause a prediction model to generate predictions related to action items, events, conversations, or documents, permissions associated with the foregoing items, expiration times associated with the foregoing items or other items (e.g., cryptographic keys), or other information. Model subsystem 114 may analyze those predictions against a set of reference feedback, such as reference predictions of information to be included in a content item or reference permissions associated therewith. In one use case, the reference outputs may be provided as input to the prediction model (e.g., prior to, simultaneously with, or subsequent to providing the content items to the prediction model), which the prediction model may utilize to determine whether its predictions are accurate, determine the level of accuracy or completeness with respect to each prediction, or other make other determinations (e.g., via deep learning through its multiple layers of abstraction or other techniques). Such determinations may be utilized by the prediction model to improve the accuracy or completeness of its predictions. In another use case, accuracy or completeness indications with respect to the prediction model's predictions (e.g., whether a given prediction is accurate, how accurate or complete a given prediction is, etc.) may be provided to the prediction model, which, in turn, may utilize the accuracy or completeness indications to improve the accuracy or completeness of its mapping predictions.

In some embodiments, prediction subsystem 118 may cause, via a prediction model (e.g., trained as described herein), an addition, modification, or removal of action items, events, conversations, documents, or other items based on one or more context sources. These operations may, for example, be automatically initiated based on the context sources. The context sources may comprise one or more other actions items, events, conversations, documents, or other context sources. As an example, one or more action items may be generated and added (e.g., to a project, action item set, etc.) based on one or more events, conversations, documents, other action items, or other items (e.g., associated with the project or those associated with other projects). Additionally, or alternatively, the action items may be modified or removed (e.g., from the project, the action item set, etc.) based on one or more events, conversations, documents, other action items, or other items (e.g., associated with the project or those associated with other projects). In one use case, a user interface may show an action item (e.g., action item no. 00008688) that may have been generated based on a conversation and a meeting (e.g., conversation no. 00001776 and meeting no. 00001984). For example, one or more fields of the meeting (e.g., a calendar invite for the meeting) may list one or more agenda items for discussion, such as which refrigerator is to be added to a kitchen of a remodeled home. During the conversation, an indication that a particular brand and color is to be purchased for the kitchen of the remodeled home may occur. The conversation (e.g., a text chat, a video chat, a teleconference call, etc.) may be recorded, and the conversation recording may be stored. If the conversation is already associated in a database with the meeting, a prediction model that processes the conversation (and previously processed the meeting) may detect that the conversation and the meeting are related based on the stored record of the association, the relatedness between the agenda items of the meeting and the discussion during the conversation (e.g., both specify refrigerators), or other criteria (e.g., time of the meeting and time of the conversation). If, for instance, the conversation and the meeting are not already associated with one another, the prediction model may detect that they are related to one another based on a predefined time of the meeting and a time that the conversation occurred, and/or based on one or more other criteria, such as the relatedness between the agenda items and the discussion during the conversation or other criteria.

Upon detecting that the meeting and the conversation are related (and/or determining that their relatedness satisfies a predefined relatedness threshold), the prediction model may utilize the contents of the meeting and the conversation to generate the action item and associate the action item with the project/action item set. In one scenario, the prediction model may perform natural language processing on the contents of the meeting and the conversation to generate the action item. For instance, if a manager approves the purchasing of a refrigerator of a particular brand and color during the conversation (e.g., “Manager A” listed on the user interface 302), this approval may be detected during processing of the contents of the conversation, and cause the action item to “Buy Brand X Refrigerator in Color Y” to be generated and added to the project/action item set.

As another example, one or more events may be initiated and added (e.g., to a project, action item set, etc.) based on one or more action items, conversations, documents, other events, or other items (e.g., associated with the project or those associated with other projects). Additionally, or alternatively, the events may be modified or removed from the project based on one or more action items, conversations, documents, other events, or other items (e.g., associated with the project or those associated with other projects). In one use case, a user interface may show a meeting (e.g., meeting no. 00001984) that may have been generated based on a conversation (e.g., conversation no. 00001774) and an action item (e.g., action item no. 00008684). For example, the action item may be created by a user to specify that a meeting to discuss kitchen appliances for a kitchen of a remodeled home should take place. If the conversation subsequently takes place and includes discussions regarding the required or optional attendees for such a meeting, the prediction model (which is provided the conversation as input) may generate a calendar invite for the meeting and add the meeting (e.g., to the project, action item set, etc.) based on the conversation. The generated calendar invite may, for instance, include the required or optional attendees based on the context subsystem 118 detecting such discussion during the conversation, as well as the title field or other fields based on the prediction model processing the fields of the action item previously created by the user.

In some embodiments, upon obtaining a list of individuals (e.g., event invitees), prediction subsystem 118 may cause a prediction model to generate predictions based on one or more attributes corresponding to each of the individuals. In one use case, prediction subsystem 118 (or the prediction model) may be trained on individuals' contact information (e.g., person's name, phone number, etc.) or other information (e.g., personal like/dislikes, allergies, etc.). In some embodiments, prediction subsystem 118 may obtain a list of individuals attending an event from an entity (e.g., a calendar application). In some embodiments, prediction subsystem 118 may automatically generate a food order which does not contain any food item that would cause an individual to have an allergic reaction. In some embodiments, prediction subsystem 118 may automatically generate one or more purchase orders for the consumables to ensure that all the food arrives for the event.

As discussed above, in some embodiments, an addition, modification, or removal of action items, events, conversations, documents, or other items may be performed via one or more prediction models (e.g., trained as described herein). In some embodiments, prediction subsystem 118 may provide information for one or more data fields of a profile (e.g., a profile associated with a user, a profile associated with a pet, or a profile associated with another type of entity, thing, or service) based on one or more predictions (generated by a prediction model). As discussed above, for example, a prediction model may be trained on at least some user information to generate predictions regarding one or more individuals or other entities (e.g., organizations or other entities). Such training information may include individuals' contact information (e.g., name, residential address, email address, social media accounts, etc.), preference information (e.g., personal like/dislikes, store preferences, food preferences, etc.), health information (e.g., medical history, family history, medications, allergies, etc.), relationship information (e.g., information regarding family, friends, or other relationships with other individuals), socioeconomic information (e.g., income information, occupation information, education information, etc.), criminal history information, or other information related to such individuals. In some embodiments, a set of prediction models may include prediction models that are each trained with respect to a user group having one or more attributes (e.g., age, gender, residential region, socioeconomic status, preferences, health histories, etc.).

In some embodiments, one prediction model may be trained on user information associated with users corresponding to one or more of an age (e.g., a specific age or age range), gender, residential region, social economic characteristic (e.g., income range, education level, type of occupation, position within company, etc.), a set of preferences, a set of health conditions, or other attribute. Another prediction model may be trained on user information associated with users corresponding to one or more of another specific age range, gender, residential region, social economic characteristic, set of preferences, set of health conditions, or other attribute. As an example, (i) a first prediction model may be trained on user information associated with users of a first age range living in a first geographic region; (ii) a second prediction model may be trained on user information associated with users of a second ethnicity a second age range living in the first geographic region, (iii) a third prediction model may be trained on user information associated with users of the first age range living in the second geographic region, and (iv) so on (e.g., other prediction models being trained on user information associated with users corresponding to other combinations of attributes).

Model subsystem 114 may provide such user information as input to the respective prediction model to train the prediction model, and such training may cause the prediction model to update one or more configurations of the prediction model. As an example, a prediction model may process information associated with one or more data fields of a user profile and, based on such processed information, predict information for one or more additional data fields of the user profile. The prediction model may then use the actual information for the additional data fields as reference feedback to assess its predicted information for the additional data field. Based on its assessment of the predicted information, the prediction model may update one or more of its configurations. As another example, the prediction model may adjust its weights, biases, or other parameters so that, if the prediction model subsequently generated a prediction for the additional data fields based on the same information of the data fields processed for the initial prediction, the subsequent prediction would match the actual information for the additional data fields (or at least be more similar to the actual information than the initial prediction is to the actual information).

As a further example, data field values provided as training information to a prediction model may include an age (e.g., a specific age or age range), gender, residential region, social economic characteristic (e.g., income range, education level, type of occupation, position within company, etc.), a set of preferences, a set of health conditions, or other data field values. In one use case, the prediction model may generate a prediction of a social economic characteristic, preference, or health condition of a user based on the user's age, gender, or residential region. The prediction model may then assess the predicted social economic characteristic, preference, or health condition against the actual social economic characteristic, preference, or health condition (e.g., provided as part of the training information) and update its configurations (e.g., weights, biases, or other parameters) based on the assessment of the predictions. In another use case, the prediction model may generate a prediction of an age, gender, or residential region of a user based on the user's social economic characteristics, preferences, or health conditions. The prediction model may then assess the predicted age, gender, or residential region against the actual age, gender, or residential region (e.g., provided as part of the training information) and update its configurations (e.g., weights, biases, or other parameters) based on the assessment of the predictions.

In some embodiments, where one or more data field values of a profile are not available to a given user (e.g., not stored on a given service, not accessible to the user due to the user lacking appropriate access rights to certain data fields of the profile, etc.), prediction subsystem 118 may cause a prediction model to generate predictions of the non-available data field values to fill in the data fields with the predicted data field values. As an example, the predicted data field values may be made available to the user as part of the profile (or appearing to be part of the profile) in lieu of indications that such actual data field values are not available to the user. In this way, if the predicted data field values are provided as part of the profile in place of all the non-available data field values, it appears to the user that the user is accessing a complete profile (e.g., a complete profile of another individual, of a pet, of an organization, or of another type of entity, thing, or service).

In some embodiments, data manager subsystem 112 may provide alternative information in lieu of non-available information (e.g., not stored on a given service, not accessible to a given user due to the user lacking appropriate access rights to such information, etc.). In one use case, with respect to FIG. 2H, content portion 228a may include a list of attributes (e.g., “Name,” “Address,” “Phone Number,” etc.) and values of at least some of the attributes (e.g., that can be shared without indicating any personal information), and content portions 228b or 228c may include values of the other attributes (e.g., the names of individuals for the “Name” attribute, the addresses of individuals for the “Address” attribute, the phone number of individuals for the “Phone Number” attribute, or other personal information). Moreover, content portion 228a may be associated with a first set of permissions (such as user role A, access level A, etc.), and content portions 228b and 228c may be associated with a second set of permissions (such as user role B, access level B, etc.). Based on the first set of permissions being associated with content portion 228a, cryptographic subsystem 116 may determine a first cryptographic key (e.g., a shared secret or other cryptographic key) as a key to be used to encrypt content portion 228a to produce data structure portion A (or an encrypted version of content portion 228a). Based on the second set of permissions being associated with content portions 228b and 228c, cryptographic subsystem 116 may determine a second cryptographic key (e.g., a public key of a public/private key pair or other cryptographic key) as a key to be used to encrypt content portions 228b and 228c to produce data structure portions B and C (or encrypted versions of content portions 228b and 228c).

In another use case, with respect to FIG. 2H, content portions 228d and 228e may include alternative information in lieu of corresponding information in content portions 228b and 228c. As an example, data manager subsystem 112 may generate (or otherwise obtain) names, addresses, phone numbers, or other information that do not include any of the actual names, addresses, phone numbers, or other information in content portions 228b and 228c, and provide such alternative information (e.g., fake information) in content portions 228d and 228e. In some cases, cryptographic subsystem 116 may use the first cryptographic key (used to encrypt content portion 228a) to encrypt content portions 228d and 228e to produce data structure portions D and E (or encrypted versions of content portions 228d and 228e). In other cases, cryptographic subsystem 116 may use a third cryptographic key (different from the first and second cryptographic keys) to encrypt content portions 228d and 228e to produce data structure portions D and E (or encrypted versions of content portions 228d and 228e).

In a further use case, with respect to FIG. 2H, based on a processing of data structure 222 (e.g., its header or other portion), each application 224 may determine what user roles or access levels are specified for each of the data structure portions A, B, C, D, and E. If the application 224 determines that its user has a user role or access level satisfying a user role or access level specified for a data structure portion, the application 224 may attempt to retrieve the cryptographic key necessary to decrypt that data structure portion to extract the corresponding content from the data structure portion. To enable application 224 to determine whether to decrypt the set of content portions 228b and 228c or the set of content portions 228d and 228e for a given user, a header or other portion of data structure 222 may indicate that data structure portions D and E are to be decrypted when it is determined that data structure portions B and C cannot be decrypted or in response to one or more other conditions. Thus, for example, application 224a may present (on its user interface 226a) content portions 228a, 228d, and 228e, and application 224b may presented (on its user interface 226) content portions 228a, 228b, and 228c. In this way, for example, a more complete end user experience may be provided to a user even though the user may not have the appropriate access rights to the actual information. Moreover, if such a user is a bad actor, the presentation of the alternative information may provide the user with the appearance that the user is viewing to all the information offered by the data structure 222, thereby avoiding any further attempt by the user to seek information in the data structure 222 that application 224a did not present.

In some embodiments, a prediction model may be used to generate seemingly realistic information about one or more entities, things, or services. In some embodiment, data manager subsystem 112 may obtain predicted information (e.g., predicted by the prediction model) and provide the predicted information as alternative information in lieu of non-available information. In one scenario, for example, a travel agency system may identify individuals, families, groups, or other entities, and provide associated vacation destinations, hotels and activities information, prioritized based on the predicted information associated with such entities (e.g., predicted preference information, health information, relationship information, socioeconomic information, or other information related to the entities). Thus, even when the travel agency system does not have information regarding an entity's preferences, health, relationships, income, or education, such information may be predicted to provide a comprehensive “picture” of the entity to generate one or more travel packages or recommendations for the entity.

In another scenario, the predicted information (e.g., predicted by the prediction model) may enhance the credibility of a presentation of a data structure to a user without access rights to certain content of the data structure portions (e.g., content hidden from the user and replaced by the predicted information in the presentation of the data structure to the user). For example, with respect to FIG. 2H, content portion 228d (presented by application 224a) may include seemingly credible combinations of predicted addresses, predicted phone numbers, or other values of attribute values, while content portion 228b (presented by application 224b) may include the actual addresses, actual phone numbers, or other information of individuals. As such, the presentation of the predicted information may provide a user (e.g., from whom information in data structure 222 is hidden) with the appearance that the user is viewing to all the information offered by the data structure 222. If, for example, the user is a bad actor, the appearance of complete information may avoid any further attempt by the user to seek information in the data structure 222 that was not presented to the user.

In some embodiments, prediction subsystem 118 may cause a prediction model to generate predictions of expiration times for one or more (i) data structures, (ii) portions of the data structures, (iii) content items represented by the data structure portions, (iv) cryptographic keys used to generate the data structure portions (or to obtain the content items from the data structure portions). In some embodiments, prediction subsystem 118 may cause a prediction model to generate predictions of expiration times for one or more predicted information (or for its associated data structures, data structures portions, cryptographic keys, etc.), and data manager subsystem 112 or cryptographic subsystem 116 may associate the predicted expiration times with the predicted information (or with its associated items).

Model subsystem 114 may provide a set of content items as input to a prediction model to train the prediction model to predict expiration times for the content items (or for items associated therewith), and such training may cause the prediction model to update one or more configurations of the prediction model. As an example, a prediction model may process information of the content items and, based on such processed information, predict expiration times for the content items (or for items associated therewith). The prediction model may then use reference expiration times (e.g., previously assigned to and stored as metadata with the content items, stored separately from the content items, etc.) as reference feedback to assess its predicted expiration times. Based on its assessment of the predicted information, the prediction model may update one or more of its configurations. As another example, the prediction model may adjust its weights, biases, or other parameters so that, if the prediction model subsequently generated a prediction for the expiration times based on the same information processed for the initial prediction, the subsequent prediction would match the reference expiration times (or at least be more similar to the reference expiration times than the initial prediction is to the reference expiration times).

Subsystems 122-124

In some embodiments, cryptographic subsystem 122 is configured to obtain a data structure and extract information from the data structure based on one or more cryptographic schemes. In some embodiments, where first and second information (e.g., first and second portions of content) are cryptographically represented in the form of first and second data structure portions of the data structure, cryptographic subsystem 122 may process the data structure to (i) determine a first cryptographic scheme for extracting data from the first data structure portion and (ii) determine a second cryptographic scheme for extracting data from the second data structure portion. Based on such determination, cryptographic subsystem 122 may obtain the first information from the first data structure portion based on the first cryptographic scheme and obtain second information from the second data structure portion based on the second cryptographic scheme.

In some embodiments, based on its processing of the data structure, cryptographic subsystem 122 may determine a first cryptographic key for extracting data from the first data structure portion and a second cryptographic key (e.g., different from the first cryptographic key) for extracting data from the second data structure portion. In some embodiments, based on its processing of the data structure, cryptographic subsystem 122 may determine a symmetric cryptographic scheme (e.g., a symmetric cryptographic algorithm, a symmetric key compatible with such algorithm, etc.) for extracting data from the first data structure portion and an asymmetric cryptographic scheme (e.g., an asymmetric cryptographic algorithm, an asymmetric key compatible with such algorithm, etc.) for extracting data from the second data structure portion. By way of example, with respect to FIG. 2F, an application's user interface 210 may present files 212a-212n to the application's user. As shown in FIG. 2F, each of body portions 214a, 214b, and 214n were generated based on a different cryptographic scheme (e.g., a different encryption key and/or a different cryptographic algorithm). Thus, in some use cases, a different decryption key (and/or a different cryptographic algorithm) must be used to decrypt each of body portions 214a, 214b, and 214n to obtain the corresponding content from the body portions 214. As an example, body portion 214a may be decrypted using a cryptographic key C1 (corresponding to cryptographic scheme C1), and body portion 214b may be decrypted using a cryptographic key C2 (corresponding to cryptographic scheme C2). Use of cryptographic key C2 is not needed to decrypt (and cannot be used to decrypt) body portion 214a. Use of cryptographic key C1 is not needed to decrypt (and cannot be used to decrypt) body portion 214b.

In one use case, with respect to the foregoing scenario related to FIG. 2F, the user has access to all files 212a-212n, but only has access (e.g., read access) to content corresponding to certain portions of each of those files 212a-212n. As such, the user may select to open each file via the application, but, when the user selects to open a particular file, the application may only present the corresponding content (of the particular file) to which the user has access. When the user selects to open file 212a, the application may process file 212a to determine which of body portions 214a-214n corresponds to content that the user has permission to access. The application may, for instance, determine from the header (or other part) of file 212a which body portions 214a-214n can be decrypted by the application to produce the corresponding content by checking whether the user is associated with any identifier that is attributed to a body portion 214 and specified in the header (or other part) of file 212a. If the user is associated with such an identifier (e.g., because the identifier identifies the user, a role to which the user belongs, an access level that the user satisfies, etc.), the application may determine that the user has access to a cryptographic key that can be used to decrypt the body portion 214 (to which the identifier is attributed).

In some use cases, with respect to the foregoing scenario related to FIG. 2F, the cryptographic key (for decrypting a given body portion 214) may be stored on the user's client device (e.g., on which the application is also hosted), and the application may obtain the cryptographic key from a secure memory of the client device (e.g., by querying the secure memory with the identifier attributed to the respective body portion 214 to obtain the cryptographic key from the secure memory). In some use cases, the cryptographic key may be stored on a server-side computer system (e.g., on behalf of the user), and the application may obtain the cryptographic key from the server-side computer system (or a database associated therewith, e.g., cryptographic database 136 or other database). As an example, the application may query the server-side computer system using the user's credentials (e.g., username, password, etc.) along with the identifier attributed to the respective body portion 214 (or other parameters). If server-side computer system determines (based on the user's credentials) that the user has the requisite access rights to the cryptographic key (which may be stored in association with the identifier), the server-side computer system may return the cryptographic key to the application.

In some embodiments, presentation subsystem 122 is configured to effectuate presentation of first information, second information, or other information that was successfully decrypted via cryptographic subsystem 122. In some embodiments, presentation subsystem 122 is configured determine one or more data structure portions that may not be properly decrypted for a given user. In some embodiments, presentation subsystem 122 is configured to indicate one or more portions of the data structure that could not be presented based on the determination that the respective data structure portions could not properly be decrypted. Such indications may be presented with the information extracted by decrypting one or more other portions of the data structure. Additionally, or alternatively, in some embodiments, presentation subsystem 122 is configured to hide one or more portions of the data structure based on the determination that the respective data structure portions could not properly be decrypted. In this way, for example, where all portions that could not be decrypted are hidden from the user, the user is given no indication that certain portions are not available to the user, thereby reducing any negative user experience related to situations in which the user realizes that he/she is restricted from certain content of a file or other data structure.

By way of example, with respect to FIG. 2G, a first user may access data structure 215 via application 216a (e.g., by specifying the “Open” command), but application 216a only presents content portion 220a on its user interface 218a (e.g., without being able to present content portions 220b and 220c to the user). On the other hand, a second user may access the same data structure 215 via application 216b (e.g., where applications 216a and 216b may be two instances of the same application) and is presented with content portions 220a, 220b, and 220c on user interface 218b. In one use case, for example, data structure 216 may include data structure portions A, B, and C that are encrypted versions of content portions 220a, 220b, and 220c, respectively, where (i) a shared secret (e.g., a private key used in conjunction with a symmetric cryptographic algorithm) is used to encrypt content portion 220a to produce data structure portion A, and (ii) a public key of a public/private key pair (e.g., used in conjunction with an asymmetric cryptographic algorithm) is used to encrypt content portions 220b and 220c. Each application 216 may process data structure 215 (e.g., its header or other part thereof) to determine the data structure portions (of data structure 215) for which the user has one or more corresponding cryptographic keys that can be used to respectively decrypt the data structure portions.

In another use case, with respect to FIG. 2G and the allergies/meals examples described herein, content portion 220a may include the list of allegories and corresponding desired meals without the names of the individuals, and content portions 220b or 220c may include the names or other personal information of the individuals who have such allergies and desire such meals. In its header or other part of data structure 215, data structure 215 may specify a user role A or an access level A for data structure portion A, where a chef, other meal preparers, and certain event managers are assigned to the user role A or satisfy access level A (e.g., they have access level A or an access level exceeding access level A). In its header or other part of data structure 215, data structure 215 may further specify a user role B or an access level B for data structure portions B and C, where the certain event managers are assigned to the user role B or satisfy access level B (where the chef or other meal preparers are not assigned to user role B or fail to satisfy access level B).

Based on a processing of data structure 215, each application 216 may determine what user roles or access levels are specified for each of the data structure portions A, B, and C. If the application 216 determines that its user has a user role or access level satisfying a user role or access level specified for a data structure portion, the application 216 may attempt to retrieve the cryptographic key necessary to decrypt that data structure portion to extract the corresponding content from the data structure portion. For data structure portion A, the application 216 may perform a query based on an identifier or other attribute of user role A or access level A (e.g., “UserRoleA,” “AccessLevelA,” a set of permissions associated with user role A or access level A, etc.) to retrieve the shared secret (used to encrypt content portion 220a). For data structure portions B and C, the application 216 may perform a query based on an identifier or other attribute of user role B or access level B (e.g., “UserRoleB,” “AccessLevelB,” a set of permissions associated with user role B or access level B, etc.) to retrieve the private key (corresponding to the public key used to encrypt content portions 220b and 220c). However, because the user of application 216a did not have a user role or access level that satisfied the specified user role or access level for data structure portions B and C, application 216a may not have attempted to retrieve (or could not retrieve) the corresponding private key needed to decrypt data structure portions B and C, and, thus, could not present content portions 220b and 220c to its user. On the other hand, application 216b is able to retrieve the corresponding private key needed to decrypt data structure portions B and C, and, as such, does present content portions 220b and 220c to its user.

As another example, with respect to FIG. 2H, a first user may access data structure 222 via application 224a (e.g., by specifying the “Open” command), but application 224a only presents content portions 228a, 228d, and 228e on its user interface 218a (e.g., without being able to present content portions 228b and 228c to the user). On the other hand, a second user may access the same data structure 222 via application 216b (e.g., where applications 224a and 224b may be two instances of the same application) and is presented with content portions 228a, 228b, and 228c on user interface 218b. In one use case, for example, data structure 216 may include data structure portions A, B, C, D, and E that are encrypted versions of content portions 228a, 228b, 228c, 228d, and 228e respectively, where (i) a first key is used to encrypt content portion 228a to produce data structure portion A, (ii) a second key is used to encrypt content portions 228b and 228c, and (iii) the first key or another key is used to encrypt content portions 228d and 228e. Each application 224 may process data structure 222 (e.g., its header or other part thereof) to determine (i) the data structure portions (of data structure 222) for which the user has one or more corresponding cryptographic keys that can be used to respectively decrypt the data structure portions, (ii) whether to decrypt or present a given content portion for the user, or (iii) or other information. In one use case, to enable the application 224 to determine whether to decrypt and present the set of content portions 228b and 228c or the set of content portions 228d and 228e, the header or other portion of data structure 222 may indicate that data structure portions D and E are to be decrypted when it is determined that data structure portions B and C cannot be decrypted or in response to one or more other conditions. In a further use case, after obtaining the appropriate keys and decrypting the corresponding content portions, application 224a may present (on its user interface 226a) content portions 228a, 228d, and 228e, and application 224b may presented (on its user interface 226) content portions 228a, 228b, and 228c. As discussed, a more complete end user experience may be provided to a user even though the user may not have the appropriate access rights to the actual information. In addition, if such a user is a bad actor, the presentation of the alternative information may provide the user with the appearance that the user is viewing to all the information offered by the data structure 222, thereby avoiding any further attempt by the user to seek information in the data structure 222 that application 224a did not present.

### Examples Flowcharts

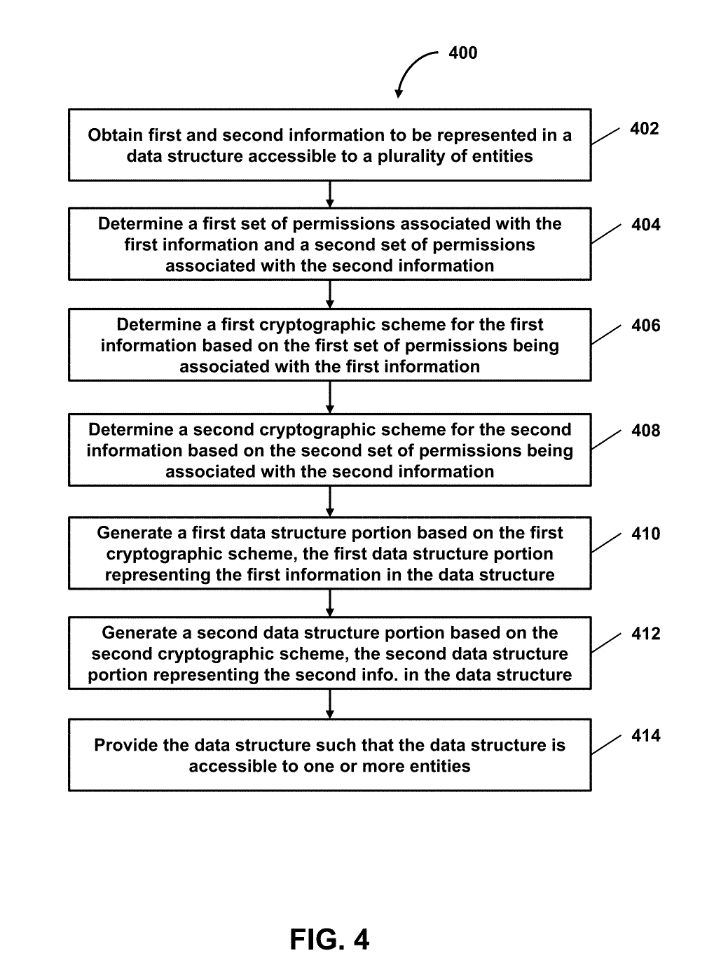

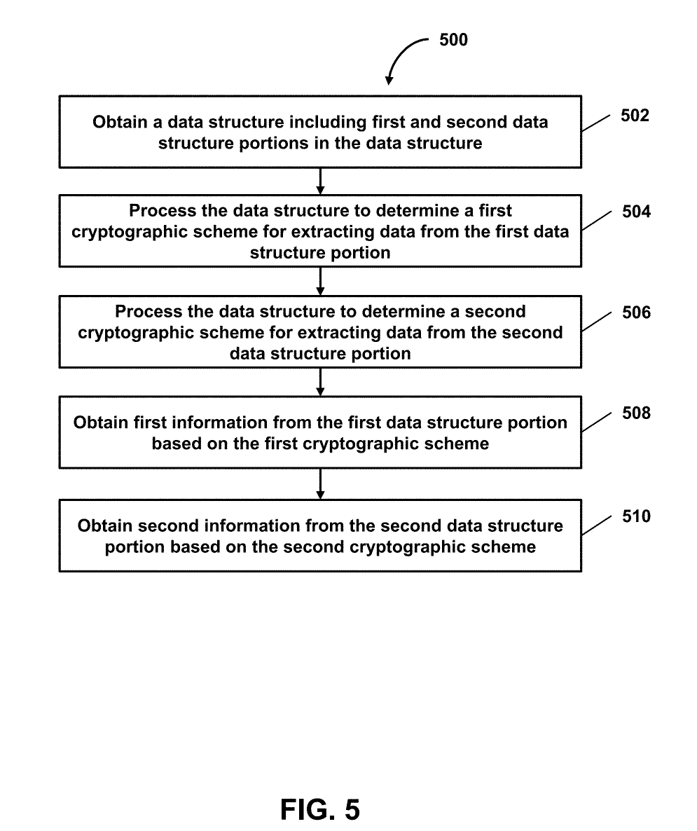

FIGS. 4 and 5 are example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 4 shows a flowchart of a method 400 of providing a data structure with different cryptographic schemes for different portions of the data structure, in accordance with one or more embodiments.

In an operation 402, first and second information to be represented in a data structure (accessible to a plurality of entities) may be obtained. The data structure may include a file, a linked list, an array, a record, or other data structure. As an example, the first information may be intended for one or more first entities, and the second information may be intended for one or more second entities. In some use cases, the first and second information may be represented in a body of the data structure (e.g., a body of the file, the linked list, the array, the record, etc.). Operation 402 may be performed by a subsystem that is the same as or similar to data manager subsystem 112, in accordance with one or more embodiments.

In an operation 404, a first set of permissions associated with the first information and a second set of permissions associated with the second information may be determined. As an example, the first set of permissions may grant write access, read access, execute access, delete access, or other type of access for one or more first entities (or one or more first groups of entities). The second set of permissions may grant write access, read access, execute access, delete access, or other type of access for one or more second entities (or one or more second groups of entities). Operation 404 may be performed by a subsystem that is the same as or similar to permissions subsystem 114, in accordance with one or more embodiments.

In an operation 406, a first cryptographic scheme may be determined for the first information based on the first set of permissions being associated with the first information. Operation 406 may be performed by a subsystem that is the same as or similar to cryptographic subsystem 116, in accordance with one or more embodiments.

In an operation 408, a second cryptographic scheme may be determined for the second information based on the second set of permission being associated with the second information. As an example, the second cryptographic scheme may be different from the first cryptographic scheme. In one use case, the first cryptographic scheme may include use of a first cryptographic key (e.g., associated with a first entity), and the second cryptographic scheme may include use of a second cryptographic key (e.g., associated with a second entity different from the first entity) different from the first cryptographic key. In another use case, the first cryptographic scheme may include a symmetric cryptographic scheme, and the second cryptographic scheme may include an asymmetric cryptographic scheme. In another use case, the first cryptographic scheme may include use of a symmetric key, and the second cryptographic scheme may include use of an asymmetric key. Operation 408 may be performed by a subsystem that is the same as or similar to cryptographic subsystem 116, in accordance with one or more embodiments.

In an operation 410, a first data structure portion may be generated based on the first cryptographic scheme. As an example, the first data structure portion may represent the first information in the data structure (e.g., in a body of the data structure, in a header of the data structure, or other portion of the data structure). As another example, the first data structure may be generated without use of the second cryptographic scheme. Operation 410 may be performed by a subsystem that is the same as or similar to cryptographic subsystem 116, in accordance with one or more embodiments.

In an operation 412, a second data structure portion may be generated based on the second cryptographic scheme. As an example, the second data structure portion may represent the second information in the data structure (e.g., in a body of the data structure, in a header of the data structure, or other portion of the data structure). As another example, the second data structure may be generated without use of the first cryptographic scheme. Operation 412 may be performed by a subsystem that is the same as or similar to cryptographic subsystem 116, in accordance with one or more embodiments.

In an operation 414, the data structure may be provided such that the data structure is accessible to one or more entities. Operation 414 may be performed by a subsystem that is the same as or similar to data manager subsystem 112, in accordance with one or more embodiments.

In some embodiments, one or more of the obtainment of the permissions, the determination of the cryptographic schemes, the generation of the data structure portions for the data structure, or other operations described herein may be automatically performed by one or more of the foregoing subsystems performing operations 402-414. As an example, the obtainment of the permissions may be performed without any further user input (i) provided subsequent to one or more of the foregoing subsystems obtaining a request to create the data structure and (ii) specifying the permissions (e.g., any of the permissions, all of the permissions, etc.). As another example, the determination of the cryptographic schemes and the generation of the data structure portions may be performed without any further user input (i) provided subsequent to one or more of the foregoing subsystems obtaining the request to create the data structure and (ii) specifying the cryptographic schemes (e.g., any of the cryptographic schemes, all of the cryptographic schemes, etc.). In some embodiments, one or more of the obtainment of the permissions, the determination of the cryptographic schemes, the generation of the data structure portions for the data structure, or other operations described herein may be automatically performed by a single application (e.g., a computer program, a mobile application, or other application) comprising or in communication with one or more of the foregoing subsystems performing operations 402-414.

FIG. 5 shows a flowchart of a method 500 of processing a data structure with different cryptographic schemes for different portions of the data structure, in accordance with one or more embodiments.

In an operation 502, a data structure (including first and second data structure portions) may be obtained. As an example, the first data structure portion may be generated based on a first cryptographic scheme, and the second data structure portion may be generated based on a second cryptographic scheme different from the first cryptographic scheme. In one use case, the first cryptographic scheme may include use of a first cryptographic key (e.g., associated with a first entity), and the second cryptographic scheme may include use of a second cryptographic key (e.g., associated with a second entity different from the first entity) different from the first cryptographic key. In another use case, the first cryptographic scheme may include a symmetric cryptographic scheme, and the second cryptographic scheme may include an asymmetric cryptographic scheme. In another use case, the first cryptographic scheme may include use of a symmetric key, and the second cryptographic scheme may include use of an asymmetric key. The data structure may include a file, a linked list, an array, a record, or other data structure. As an example, the first information may be intended for one or more first entities, and the second information may be intended for one or more second entities. In some use cases, the first and second information may be represented in a body of the data structure (e.g., a body of the file, the linked list, the array, the record, etc.). Operation 502 may be performed by a subsystem that is the same as or similar to cryptographic subsystem 122, in accordance with one or more embodiments.

In operations 504 and 506, the data structure may be processed to determine the first cryptographic scheme for extracting data from the first data structure portion and the second cryptographic scheme for extracting data from the second data structure portion. As an example, the data structure may be processed to determine a first cryptographic key for extracting data from the first data structure portion and a second cryptographic key (different from the first cryptographic key) for extracting data from the second data structure portion. As another example, the data structure may be processed to determine a symmetric cryptographic scheme for extracting data from the first data structure portion and an asymmetric cryptographic scheme for extracting data from the second data structure portion. As another example, the data structure may be processed to determine a symmetric key for extracting data from the first data structure portion and an asymmetric key for extracting data from the second data structure portion. Operations 504 and 506 may be performed by a subsystem that is the same as or similar to cryptographic subsystem 122, in accordance with one or more embodiments.

In an operation 508, the first information may be obtained from the first data structure portion based on the first cryptographic scheme. As an example, the first information may be obtained from the first data structure portion without use of the second cryptographic scheme. Operation 508 may be performed by a subsystem that is the same as or similar to cryptographic subsystem 122, in accordance with one or more embodiments.

In an operation 510, second information may be obtained from the second data structure portion based on the second cryptographic scheme. As an example, the second information may be obtained from the second data structure portion without use of the first cryptographic scheme. Operation 510 may be performed by a subsystem that is the same as or similar to cryptographic subsystem 122, in accordance with one or more embodiments.

In some embodiments, with respect to operations 508 and 510, the first information may be obtained from the first data structure portion by using the first cryptographic key (of the first cryptographic scheme) to decrypt the first data structure portion to produce the first information (e.g., without use of the second cryptographic key, with use of the second cryptographic key, etc.). The second information may be obtained from the second data structure portion by using the second cryptographic key (of the second cryptographic scheme) to decrypt the second data structure portion to produce the second information (e.g., without use of the first cryptographic key, with use of the first cryptographic key, etc., etc.).

In some embodiments, with respect to operations 508 and 510, the first information may be obtained from the first data structure portion by using the symmetric cryptographic scheme (e.g., including use of the symmetric key) to decrypt the first data structure portion to produce the first information (e.g., without use of the asymmetric key, with use of the asymmetric key, etc.). The second information may be obtained from the second data structure portion by using the asymmetric cryptographic scheme (e.g., including use of the asymmetric key) to decrypt the second data structure portion to produce the second information (e.g., without use of the symmetric key, with use of the symmetric key, etc.).

In some embodiments, one or more of the determination of the cryptographic schemes (e.g., including which cryptographic schemes are associated with the user or other related determinations), the obtainment of the information from the data structure portions, or other operations described herein may be automatically performed by one or more of the foregoing subsystems performing operations 502-510. As an example, the determination of the cryptographic schemes and the obtainment of the information from the data structure portions may be performed without any further user input (i) provided subsequent to one or more of the foregoing subsystems obtaining a request to access at least one of the data structure portions (or the corresponding content portions) and (ii) specifying the cryptographic schemes (e.g., any of the cryptographic schemes, all of the cryptographic schemes, etc.). In some embodiments, one or more of the determination of the cryptographic schemes, the obtainment of the information from the data structure portions, or other operations described herein may be automatically performed by a single application (e.g., a computer program, a mobile application, or other application) comprising or in communication with one or more of the foregoing subsystems performing operations 502-510.

In some embodiments, the various computers and subsystems illustrated in FIG. 1 may include one or more computing devices that are programmed to perform the functions described herein. The computing devices may include one or more electronic storages (e.g., management database(s) 132, which may include permissions database(s) 134, cryptographic database(s) 136, context database(s) 138, etc., or other electric storages), one or more physical processors programmed with one or more computer program instructions, and/or other components. The computing devices may include communication lines or ports to enable the exchange of information with a network (e.g., network 150) or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide data processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-124 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-124 described herein is for illustrative purposes, and is not intended to be limiting, as any of subsystems 112-124 may provide more or less functionality than is described. For example, one or more of subsystems 112-124 may be eliminated, and some or all of its functionality may be provided by other ones of subsystems 112-124. As another example, additional subsystems may be programmed to perform some or all of the functionality attributed herein to one of subsystems 112-124.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The present techniques will be better understood with reference to the following enumerated embodiments:

1. A method comprising: obtaining first and second information to be represented in a body of a data structure accessible to a plurality of entities; determining a first set of permissions associated with the first information and a second set of permissions associated with the second information; determining a first cryptographic scheme for the first information based on the first set of permissions being associated with the first information and a second cryptographic scheme for the second information based on the second set of permission being associated with the second information; generating a first data structure portion based on the first cryptographic scheme, the first data structure portion representing the first information in the data structure; generating a second data structure portion based on the second cryptographic scheme, the second data structure portion representing the second information in the body of the data structure; and providing the data structure comprising the first and second data structure portions such that the data structure is accessible to one or more entities.
2. The method of embodiment 1, wherein the data structure comprises a file, and the file comprises the first and second data structure portions.
3. The method of any of embodiments 1-2, wherein the data structure comprises a linked list, and the linked list comprises the first and second data structure portions.
4. The method of any of embodiments 1-3, wherein the data structure comprises an array, and the array comprises the first and second data structure portions.
5. The method of any of embodiments 1-4, wherein the data structure comprises a record, and the record comprises the first and second data structure portions.
6. The method of any of embodiments 1-5, further comprising: determining the first cryptographic scheme for the first information by determining a first cryptographic key for the first information based on the first set of permissions being associated with the first information; determining the second cryptographic scheme for the second information by determining a second cryptographic key for the second information based on the second set of permission being associated with the second information; generating the first data structure portion by using the first cryptographic key to encrypt the first information to produce the first data structure portion; and generating the second data structure portion by using the second cryptographic key to encrypt the second information to produce the second data structure portion.
7. The method of embodiment 6, wherein the first data structure portion is generated without use of the second cryptographic key.
8. The method of any of embodiments 6-7, wherein the second data structure portion is generated without use of the first cryptographic key.
9. The method of any of embodiments 1-8, further comprising: determining the first cryptographic scheme for the first information by determining a symmetric key for the first information based on the first set of permissions being associated with the first information; determining the second cryptographic scheme for the second information by determining an asymmetric key for the second information based on the second set of permission being associated with the second information; generating the first data structure portion by using the symmetric key to encrypt the first information to produce the first data structure portion; and generating the second data structure portion by using the asymmetric key to encrypt the second information to produce the second data structure portion.
10. The method of embodiment 9, wherein the first data structure portion is generated without use of the asymmetric key.
11. The method of any of embodiments 9-10, wherein the second data structure portion is generated without use of the symmetric key.
12. The method of any of embodiments 1-11, further comprising: determining the first cryptographic scheme for the first information by determining a symmetric cryptographic scheme for the first information based on the first set of permissions being associated with the first information; determining the second cryptographic scheme for the second information by determining an asymmetric cryptographic scheme for the second information based on the second set of permission being associated with the second information; generating the first data structure portion by using the symmetric cryptographic scheme to encrypt the first information to produce the first data structure portion; and generating the second data structure portion by using the asymmetric cryptographic scheme to encrypt the second information to produce the second data structure portion.
13. The method of embodiment 12, wherein the first data structure portion is generated without use of the asymmetric cryptographic scheme.
14. The method of any of embodiments 12-13, wherein the second data structure portion is generated without use of the symmetric cryptographic scheme.
15. The method of any of embodiments 1-14, wherein the first cryptographic scheme comprises use of a first cryptographic key associated with a first entity, and wherein the second cryptographic scheme comprises use of a second cryptographic key associated with a second entity.
16. The method of any of embodiments 1-15, wherein the first data structure portion represents the first information in a body of the data structure, and wherein the second data structure portion represents the second information in the body of the data structure.
17. The method of any of embodiments 1-16, wherein the first data structure portion is generated without use of the second cryptographic scheme.
18. The method of any of embodiments 1-17, wherein the second data structure portion is generated without use of the first cryptographic scheme.
19. A method comprising: obtaining a data structure comprising first and second data structure portions in the data structure, the first data structure portion being generated based on a first cryptographic scheme, and the second data structure portion being generated based on a second cryptographic scheme; processing the data structure to determine the first cryptographic scheme for extracting data from the first data structure portion and the second cryptographic scheme for extracting data from the second data structure portion; obtaining first information from the first data structure portion based on the first cryptographic scheme; and obtaining second information from the second data structure portion based on the second cryptographic scheme.
20. The method of embodiment 19, wherein the data structure comprises a file, and the file comprises the first and second data structure portions.
21. The method of any of embodiments 19-20, wherein the data structure comprises a linked list, and the linked list comprises the first and second data structure portions.
22. The method of any of embodiments 19-21, wherein the data structure comprises an array, and the array comprises the first and second data structure portions.
23. The method of any of embodiments 19-22, wherein the data structure comprises a record, and the record comprises the first and second data structure portions.
24. The method of claim 19, further comprising: determining the first cryptographic scheme by determining a first cryptographic key for extracting data from the first data structure portion; determining the second cryptographic scheme by determining a second cryptographic key for extracting data from the second data structure portion; obtaining the first information from the first data structure portion by using the first cryptographic key to decrypt the first data structure portion to produce the first information; and obtaining second information from the second data structure portion by using the second cryptographic key to decrypt the second data structure portion to produce the second information.
25. The method of embodiment 24, wherein the first information is obtained from the first data structure portion without use of the second cryptographic key.
26. The method of any of embodiments 24-25, wherein the second information is obtained from the second data structure portion without use of the first cryptographic key.
27. The method of claim 19, further comprising: determining the first cryptographic scheme by determining a symmetric key for extracting data from the first data structure portion; determining the second cryptographic scheme by determining an asymmetric key for extracting data from the second data structure portion; obtaining the first information from the first data structure portion by using the symmetric key to decrypt the first data structure portion to produce the first information, the first information being obtained from the first data structure portion without use of the asymmetric key; and obtaining second information from the second data structure portion by using the asymmetric key to decrypt the second data structure portion to produce the second information, the second information being obtained from the second data structure portion without use of the symmetric key.
28. The method of embodiment 27, wherein the first information is obtained from the first data structure portion without use of the asymmetric key.
29. The method of any of embodiments 27-28, wherein the second information is obtained from the second data structure portion without use of the symmetric key.
30. The method of any of embodiments 19-29, further comprising: determining the first cryptographic scheme for the first information by determining a symmetric cryptographic scheme for extracting data from the first data structure portion; determining the second cryptographic scheme for the second information by determining an asymmetric cryptographic scheme for extracting data from the second data structure portion; obtaining the first information from the first data structure portion by using the symmetric cryptographic scheme to decrypt the first data structure portion to produce the first information; and obtaining the second information from the second data structure portion by using the asymmetric cryptographic scheme to decrypt the second data structure portion to produce the second information.
31. The method of embodiment 30, wherein the first information is obtained from the first data structure portion without use of the asymmetric cryptographic scheme.
32. The method of any of embodiments 30-31, wherein the second information is obtained from the second data structure portion without use of the symmetric cryptographic scheme.
33. The method of any of embodiments 19-32, wherein the first cryptographic scheme comprises use of a first cryptographic key associated with a first entity, and wherein the second cryptographic scheme comprises use of a second cryptographic key associated with a second entity, the second cryptographic key being different from the first cryptographic key.
34. The method of any of embodiments 19-33, wherein the data structure comprises the first and second data structure portions in a body of the data structure.
35. The method of any of embodiments 19-34, wherein the first information is obtained from the first data structure portion without use of the second cryptographic scheme.
36. The method of any of embodiments 19-35, wherein the second information is obtained from the second data structure portion without use of the first cryptographic scheme.
37. A tangible, non-transitory, machine-readable medium storing instructions that when executed by a data processing apparatus cause the data processing apparatus to perform operations comprising those of any of embodiments 1-36.
38. A system comprising: one or more processors; and memory storing instructions that when executed by the processors cause the processors to effectuate operations comprising those of any of embodiments 1-36.

What is claimed is:

1. A method of providing a prediction-based data structure that is encrypted with different cryptographic keys for different body portions of the data structure, the method being implemented by a computer system that comprises one or more processors executing computer program instructions that, when executed, perform the method, the method comprising:
causing a prediction model to predict information related to information in content items;
providing one or more target output indications as reference feedback to the prediction model to cause the prediction model to assess the predicted information against the one or more target output indications, the prediction model updating one or more portions of the prediction model based on the prediction model's assessment of the predicted information;
causing the prediction model to predict first information related to second information;
responsive to the prediction model predicting the first information, performing the following operations to create a data structure comprising (i) a header (ii) a body in which the first and second information are to be represented by first and second data structure portions:
encrypting the first information with a cryptographic key to generate the first data structure portion, the first data structure portion being generated using the cryptographic key and without using another cryptographic key;
encrypting the second information with the other cryptographic key to generate the second data structure portion, the second data structure portion being generated using the other cryptographic key and without using the cryptographic key; and
creating the data structure comprising the first and second data structure portions; and
providing the data structure to a user device external to the computer system.

2. The method of claim 1, wherein the data structure comprises a file, and a body of the file comprises the first and second data structure portions.

3. The method of claim 1, wherein the data structure comprises a linked list, array, or record, and a body of the linked list, array, or record comprises the first and second data structure portions.

4. The method of claim 1, further comprising:
obtaining third information comprising one or more values associated with one or more attributes, wherein the first information comprises at least one predicted value associated with at least one of the one or more attributes;
encrypting the third information with at least one cryptographic key different from the other cryptographic key to generate a third data structure portion, wherein the third information is to be represented by the third data structure portion in the body of the data structure; and
creating the data structure to comprise the first, second, and third data structure portions.

5. The method of claim 1, wherein the cryptographic key is associated with a first user.

6. The method of claim 5, wherein the other cryptographic key is not associated with the first user.

7. The method of claim 1, wherein the cryptographic key is an asymmetric key, and the other cryptographic key is a symmetric key.

8. The method of claim 1, wherein the cryptographic key is a symmetric key, and the other cryptographic key is an asymmetric key.

9. The method of claim 1, wherein the content items comprise action items, events, conversations, or documents.

10. The method of claim 1, wherein the content items comprise information associated with individuals, wherein the first information predicted by the prediction model comprises preference information associated with one or more individuals, and wherein the second information comprises identifying information associated with one or more individuals.

11. A system comprising:
a computer system comprising one or more processors programmed with computer program instructions that, when executed, cause the computer system to:
cause a prediction model to predict information related to information in content items;
provide one or more target output indications as reference feedback to the prediction model to cause the prediction model to assess the predicted information against the one or more target output indications, the prediction model updating one or more portions of the prediction model based on the prediction model's assessment of the predicted information;
cause the prediction model to predict first information related to second information;
responsive to the prediction model predicting the first information, perform the following operations to create a data structure comprising (i) a header (ii) a body in which the first and second information are to be represented by first and second data structure portions:
encrypting the first information with a cryptographic key to generate the first data structure portion, the first data structure portion being generated using the cryptographic key and without using another cryptographic key;
encrypting the second information with the other cryptographic key to generate the second data structure portion, the second data structure portion being generated using the other cryptographic key and without using the cryptographic key; and
creating the data structure comprising the first and second data structure portions; and
provide the data structure to a user device external to the computer system.

12. The system of claim 11, wherein the data structure comprises a file, and the file comprises the first and second data structure portions.

13. The system of claim 11, wherein the data structure comprises a linked list, array, or record, and the linked list, array, or record comprises the first and second data structure portions.

14. The system of claim 11, wherein the computer system is caused to:
obtain third information comprising one or more values associated with one or more attributes, wherein the first information comprises at least one predicted value associated with at least one of the one or more attributes;
encrypt the third information with at least one cryptographic key different from the other cryptographic key to generate a third data structure portion, wherein the third information is to be represented by the third data structure portion in the body of the data structure; and
create the data structure to comprise the first, second, and third data structure portions.

15. The system of claim 11, wherein the cryptographic key is associated with the first user.

16. The system of claim 14, wherein the other cryptographic key is not associated with the first user.

17. The system of claim 11, wherein the cryptographic key is an asymmetric key, and the other cryptographic key is a symmetric key.

18. The system of claim 11, wherein the cryptographic key is a symmetric key, and the other cryptographic key is an asymmetric key.

19. The system of claim 11, wherein the content items comprise information associated with individuals, wherein the first information predicted by the prediction model comprises preference information associated with one or more individuals, and wherein the second information comprises identifying information associated with one or more individuals.

20. A non-transitory computer-readable medium storing instructions that, when executed by one or more processors, cause the one or more processors to perform operations comprising:
causing a prediction model to predict information related to information in content items;
providing one or more target output indications as reference feedback to the prediction model to cause the prediction model to assess the predicted information against the one or more target output indications, the prediction model updating one or more portions of the prediction model based on the prediction model's assessment of the predicted information;
causing the prediction model to predict first information related to second information;
responsive to the prediction model predicting the first information, performing the following operations to create a data structure comprising (i) a header (ii) a body in which the first and second information are to be represented by first and second data structure portions:
encrypting the first information with a cryptographic key to generate the first data structure portion, the first data structure portion being generated using the cryptographic key and without using another cryptographic key;
encrypting the second information with the other cryptographic key to generate the second data structure portion, the second data structure portion being generated using the other cryptographic key and without using the cryptographic key; and
creating the data structure comprising the first and second data structure portions; and
providing the data structure to a user device external to the computer system.
